(19) United States
(12) Patent Application Publication
(10) Pub. No.: US 2006/0249926 A1
(43) Pub. Date: Nov. 9, 2006

(54) Tow bar

(76) Inventor: Philip N. Smith, Pensacola, FL (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/125,452

(22) Filed: May 9, 2005

(51) Int. Cl. B60D 1/54

(52) U.S. Cl. 280/491.1

(57) ABSTRACT

A tow bar device for pulling a towed vehicle behind a towing vehicle. The device features a pair of legs formed of translating leg components having an extended position and collapsed position. During rearward travel of the towing vehicle in a curved direction, the legs translate to longer or shorter lengths between the extended and collapsed position. Resistance to translation toward the collapsed position is provided by one or a combination of a biasing means and damper to thereby help equalize the force imparted to the towed vehicle to avoid steering lockup from excessive force to either front side of the towed vehicle.

Motorhomes are large ungainly vehicles—some stretching to forty feet in length--and are thus not the ideal vehicle to drive through shopping centers and small town streets during a vacation. Additionally motorhomes and the like use fuel at a high rate due to their size and weight and thus are uneconomical to drive at a stopping point during a long trip.

Consequently, many motorhome drivers have taken to towing a small car or other two axle steerable vehicle behind the large motorhome. With such a vehicle in tow, when the motorhome docks in a town or vacation venue, the smaller vehicle may be unhooked and used as a runabout for local travel. This saves fuel, money, and especially patience when looking for parking or traversing the local mall parking lot.

However, a problem exists for motorhome drivers in the everyday requirement of backing up the motorhome with the towed vehicle attached to the rear. Cars and other front steered vehicles being pulled forward in tow generally keep their front wheels on the steering axle in a straight line due to the in line nature of forward travel and the fact that the front wheels are the forward axle in the direction of travel.

On the other hand, backing up a towed steerable vehicle, using the towing vehicle to push it rearward, is a continual problem. This is because the wheels on the front steering axle of the towed vehicle tend to turn when there is a curve in the path of the towed vehicle being backed up. This tendency to turn causes the wheels to rotate and an eventual lock-up of the steering mechanism of the towed vehicle during its backward travel. It has been found through experimentation that one of the prime causes of steering lock up is the impartation of excess pressure by the tow bar to one side of the bumper of the towed vehicle in the direction of a curved back up path.

U.S. Pat. No. 5,711,542 (Kendall) teaches a triangular hitch adapter for a towed vehicle. While Kendal talks of a construction that allows the user to change the length of the two legs, it is a fixed engagement and offers no telescopic attributes nor any means to buffer the forces of the engaged tow bar and would therefore still lock up the trailing vehicle in reverse.

U.S. Pat. No. 4,861,061 (Frantz) shows a triangular shaped tow bar and allows for adjustment of arm length. However, Frantz too lacks the selectable telescopic function of applicant's device and biasing of the two leg parts. Nor does Frantz provide a dampening or buffering of the force imparted to the towed vehicle during back up. It too would lock up the trailing vehicle when pushed in reverse.

U.S. Pat. No. 5,765,851 (Parent) also teaches a V-shaped or triangular style tow bar for towing vehicles. Parent offers the ability to change leg length to align the vehicles but lacks the selectable telescopic function of applicant's device and delayed bias or dampening of telescopic force of the two leg parts and would also lock up the steering of the towed vehicle.

As such, there is an unmet need for a tow bar for two axle steered vehicles which will allow for inline or straight forward towing of the towed vehicle. Such a device should also allow the towed vehicle to follow a curved path when backing it up behind the towing vehicle. Such a device should provide a means to prevent the front wheels of the towed vehicle from locking up when it is backed up in a curved path by the towing vehicle moving in reverse by dampening the forces imparted to both sides of the front bumper during rearward maneuvers. Still further, such a tow bar device should be easy to adjust and easy to engage between the towed vehicle and the towing vehicle.

### SUMMARY OF THE INVENTION

The device herein disclosed and described features an improved “V” shaped tow bar formed of a plurality of at least two telescopically engaged legs which join at a front portion or first leg component to an engagement to a trailer hitch. The rearward or distal ends of the telescopically engaged legs shown herein as formed of a second leg component telescopically engaged with the first are adapted for attachment to a vehicle to be towed. While each of the two legs is shown formed of at least two telescoping components with each assembled leg having an extended position and compressible to a retracted position, those skilled in the art will no doubt realize that such plurality of legs could be more than two. Further, the legs might be a plurality of members that are translatably engaged and not necessarily in a sealed closed telescopic engagement and such is anticipated by this disclosure.

In the extended position for general towing with the towed vehicle pulled by the towing vehicle in a forward direction the legs are locked and the two or more translating components making up each leg will thus not translate rendering the legs fixed in length. When the towed vehicle is to be backed-up in a rearward direction, each leg may be unlocked to thereby allow a translation of the plurality of translating leg components in relation to each other. In the unlocked position as shown herein with two leg components, the 2nd leg component, attached to the car or other steerable vehicle being towed, will translate a distance toward the 1st leg component hooked to the towing vehicle. In the simplest embodiment of the device during this distance of travel toward the first leg by the second, a first portion of distance of free travel is provided with no resistance. Once the second leg travels past the distance allotted for free travel, the 2nd leg component will encounter a biasing means such as a spring which will bias the 2nd leg away from the first leg, keeping it from bottoming out.

During backing up with the two legs unlocked, when the towing vehicle curves rearward, the 2nd leg component on the outside of the curve of the towed vehicle will tend to translate in its engagement to the 1st leg component and allow just enough slack in the force on one side of the front of the towed car being pushed to keep the steering wheels on the towed car from rotating and locking up.

After a period of free translation, a spring biases the two leg components apart until or unless total compression occurs. At that point a bumper of urethane or similar material stops further translation and resulting shortening of the two leg components.

Due to the forces imparted rearward by the towing vehicle, the leg on the longer side of the curve will generally take longer to fully compress, and the leg on the short side of the curve compresses more. The result is that the towed vehicle being pushed by the rearward moving towing vehicle along a curved path to the rear of the towing vehicle will follow that curve and thus locking up of the towed car's steering is prevented due to the forces acting on the front of the towed vehicle by the translating components of the two legs of the tow bar. Not only does it provide smoother backing for the user, the potential for mechanical damage to the towed vehicle's steering system locking up is reduced or eliminated.

In another preferred embodiment of the device, a means for continual resistance to translation of the leg engaged to the towed vehicle toward and away from the leg engaged with the towing vehicle is employed. The current best means for resistance to this translation is provided by a conventional steering damper which is designed to provide hydraulic resistance when mounted horizontally. As the towing vehicle backs up to push the towed vehicle rearward, the steering damper continually imparts a slight force of resistance to the translation of the plurality of components forming the legs. The leg generating the most force will collapse quicker than the leg with less force, thereby equalizing the force imparted by the rearward portion of the legs engaged with the towed vehicle. In doing so, the towed vehicle's steering will tend not to oversteer which is the cause of steering lockup and eventual damaged steering boxes and steering components. This embodiment can be supplemented with a spring to increase the dampening effect when the components reach maximum collapse of a leg.

The locking means which maintains the components forming the collapsible leg in their expanded position could be mechanical or could be provided in an electronic form using a solenoid. The electronic version would be most appreciated by users who are backing up a towed vehicle in the rain or inclement weather. The solenoid would default to a position locking the components forming the legs in their expanded position. When energized the solenoid would unlock the components and allow for the translation toward the collapsed position.

The mechanical locking means can be spring-loaded or otherwise maintained in the default locked position and released by means for mechanical release of the locking means. Currently such a device is shown in the drawings using a gravity-activated lever which maintains the leg components locked unless released by downward pressure on a tiltable arm. Of course those skilled in the art will realize that other means of locking the leg components in their respective expanded position can be used and such are anticipated.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

It is an object of this invention to provide an improved tow bar to attach vehicles to be towed to vehicles towing them.

It is another object of this invention to provide a tow bar for steerable vehicles for towing behind a motorhome.

It is a still further object of this invention to provide a tow bar for vehicles being towed that will allow for a curved path in the rearward movement of the towed vehicle and prevent or avoid a lockup of the towed vehicle's steering mechanism from oversteer.

It is a further object of this invention to provide such a tow bar system which has translatable arms which resistibly collapse using a dampening means which helps equalize force applied to the front of the towed vehicle moving in reverse.

Further objects of the invention will be brought out in the following part of the specification wherein detailed description is for the purpose of fully disclosing the invention without placing limitations thereon.

### BRIEF DESCRIPTION OF DRAWING FIGURES

FIG. 1 is a perspective view of a first preferred embodiment of the invention showing the two legs of the device composed of a plurality of at least two elongated telescopic or translatable leg components in their elongated positions.

FIG. 2 depicts another preferred embodiment of the device herein wherein a frictional motion dampening means is engaged to dampen collapse of both leg components during rearward travel of the towed vehicle.

FIG. 3 depicts an embodiment of the device showing a hydraulic means for dampening the travel of the leg components as the legs collapse in length.

FIG. 4 depicts the embodiment of the device employing a bumper which contacts a spring and additional bumper when the leg reaches its collapsed or shortest position.

### DETAILED DESCRIPTION OF THE PREFERRED EMBODIMENTS OF THE INVENTION

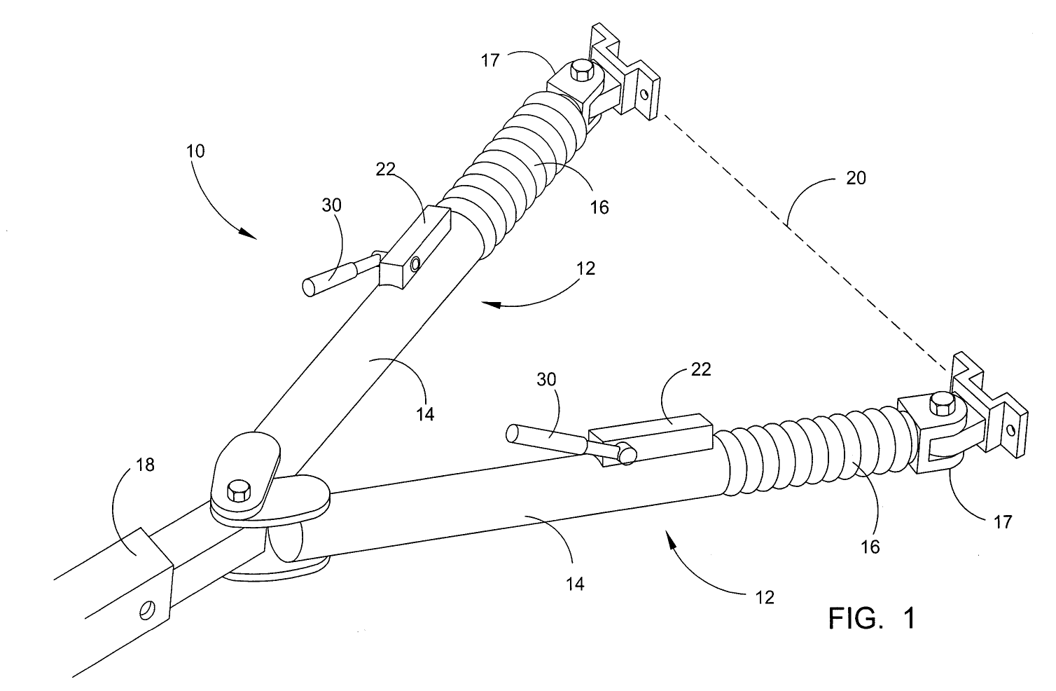

Referring now to the drawings of FIGS. 1-4, FIG. 1 is a perspective view of a first preferred embodiment of the tow bar device 10 which features an improved “V” shaped tow hitch or tow bar formed of two legs 12. Each leg 12 is formed of a plurality of elongated leg portions which are telescopically engaged. Of course those skilled in the art will realize that the leg 12 can be formed of more than two leg portions and that the components may simply be translatably engaged members and need not necessarily be round a telescopically engaged conduit and all such collapsible engagement of translatable members to form the leg 12 are anticipated. However, the current preferred mode of the device 10 employs round telescopically engaged components to provide a substantially sealed axial chamber 11 inside the telescopically engaged leg portions forming each leg 12.

In a preferred mode of the device shown in FIG. 1, a first or front leg portion 14 is adapted at a distal end for engagement to a trailer hitch 18. The rear leg portion 16 is engaged for translation with, or telescopically to, the distal end to the front leg portion 14. The distal end of the rear leg portion 16 is adapted for engagement to the vehicle 20 being towed using the shown brackets 17 or other means for engagement with a towed vehicle 20. Each of the two legs 12 are formed of at least two translatably or telescopically engaged leg components and each leg 12 as a consequence has an extended position fully elongated as in FIG. 1 and may be translated to a retracted position as where the leg is shortest in length.

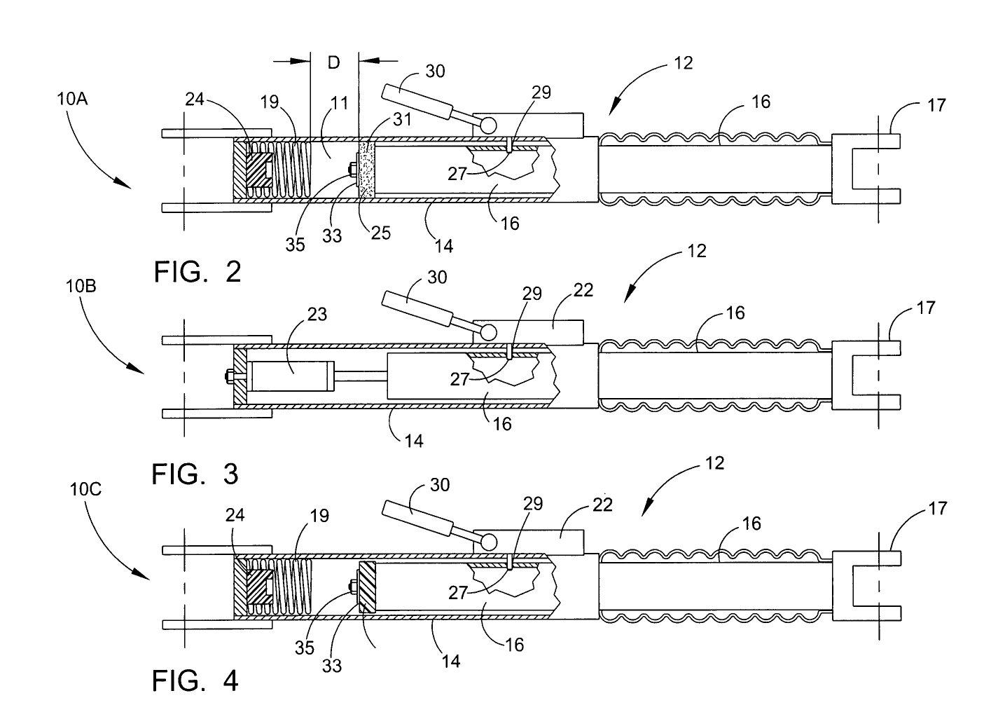

For general towing in the forward direction of the towing vehicle, both legs 12 are in a fixed engagement in the extended position locked in place by a means for releasable lock 22 which removably locks the plurality of leg sections in the extended position. This locked engagement maintains the legs in their elongated position during forward travel over the streets and highways. However, it should be noted that when the device employs a permanent dampening means from a group of dampers such as a frictional damper of FIG. 2 or a hydraulic damper 23 as shown in FIG. 3, during forward travel of the engaged vehicles, the device 10 will tend to remain in the extended position anyway, and during rearward travel resistance is imparted to thereby keep the towed vehicle substantially engaged with the towing vehicle without any slack that might cause forward steering problems. Consequently, the locking means such as releasable lock 22 might be omitted if the hydraulic damper 23 is employed. Due to the long stretches of highway frequently traveled by users of such towing devices, it would save wear and tear on the hydraulic damper 23 if the legs 12 are locked in their extended positions.

In use, when the towed vehicle 20 is to be backed up in a rearward direction by a pushing force from the towing vehicle, each leg 12 is unlocked to thereby allow a translation of the respective front leg component 14 in its engagement to the rear leg component 16. In the unlocked position with the means for releasable locked engagement provided by lock 22 the leg sections become translatably disengaged. In the simplest embodiment of the legs of the device shown in FIG. 4, the rear leg component 16, attached to the towed vehicle 20 will first translate a distance of unrestricted free travel shown as distance “D” shown in FIG. 2, toward the front leg component 14 hooked to the towing vehicle. This could of course be reversed depending on construction of the device 10. As noted, during this distance “D” of travel toward the front leg 14 by the rear leg 16, the travel is free or unbiased in the embodiment of FIG. 4. When the dampening means such as hydraulic damper 23 shown in FIG. 3 or frictional damper 25 shown in FIG. 2 are employed along with the spring 19, collapse of the leg during the distance “D” will be slightly biased by the resistance created by the damper 23 during that travel. This resistance by the damper 23 can be in one or both directions of translation depending on the design, as some dampers 23 provide resistance in one direction and no or less resistance in the other. The means for dampening employed with or without the spring 19 can be either the frictional or hydraulic type or other types of damper devices.

Once the rear leg 16 traverses distance “D” it will encounter a means to resist translation toward the collapsed position in the form of a biasing means such as a spring 19 which will bias the engaged leg components toward the elongated position. The length of the spring 19 would determine the length of resistance to collapse in the simplest embodiment of FIG. 4. Once the spring 19 is fully compressed by the translation of the front leg portion 14 with the rear leg portion 16, a bumper 24 made from a rubber or urethane material provides a stop or means to further prevent collapse of the components making up the leg 12.

When a permanent hydraulic damper 23 is employed, the bumper 24 may not be required since the damper 23 will provide the means to prevent further collapse of the components. However it can be added to protect the damper 23 from damage from compression if desired. The spring may not be necessary either in a version of the device 10 with the fewest parts since the damper 23 can provide the means to resist collapse of the legs 12 without the spring if desired. However, the spring 19 and bumper 24 can be used in conjunction with the damper 23 to keep the damper 23 from becoming damaged from too much compressive force being imparted to it which might damage it.

In use, in all preferred embodiments during backing up of the towed vehicle 20, the two legs 12, if locked as in the preferred embodiments, are unlocked by manual or electronic release of the locking means so that the leg components 14 and 16 will translate in their respective engagement. In a curved path where no damper means is employed, when the towed vehicle 20 curves rearward, the rear leg component 16 on the longer side of the curve will tend to translate in its engagement to the front leg component 14 during distance “D” and allow just enough slack in its force on the front of the towed vehicle 20 being pushed to keep the steering wheels on the front axle on the towed car from over-rotating and locking up the steering box. The same unequal collapsing action occurs on the embodiments employing either the hydraulic or frictional means for dampening the translation of the leg components since one leg will collapse slightly faster than the other depending on the forces imparted. The dampening means will also impart a limited amount of force rearward before slipping or compressing. Using a dampening means in each leg 12, such as the hydraulic damper 23 or frictional damper 25, which is calibrated to slide or allow collapse of the leg 12 at a certain force, provides a means to substantially equalize the force each leg 12 imparts to the towed vehicle 20 in the rearward direction. This equalization of force on the towed vehicle 20 will cause the towed vehicle 20 to back up on a curve without oversteering and locking up the steering mechanisms as occurs when using solid tow bars which will impart more force to one leg 12 than the other on a curved rearward course.

Current preferred means for dampening free travel of the leg components between the expanded and collapsed position is shown in FIG. 3 as hydraulic damper 23, or could be provided by frictional damper 25 shown in FIG. 2 which as shown employs a rubber or other soft washer 31 compressed between a washer 33 by compression means such as nut 35. The side edges of the soft washer 31 would thereby impart friction against the inside surface of front leg component 14 providing a dampening of collapse and extension of the components forming the leg 12. In the same fashion, force is imparted by the towing vehicle to the towed vehicle in a fashion which substantially equalizes pressure on the towed vehicle 20 during curved rearward travel.

The means for dampening uses some of the pushing energy through either friction or pumping of hydraulic fluid in the normal action of such devices thus equalizing the force to the towed vehicle being backed in a curved path. In the embodiment without the damper action the free travel distance provides a similar equalizing of the force to the rearward vehicle pushed in a curved path. The resulting force on the front of the towed vehicle pushes it in the curved rearward path and locking up of the towed car's steering is prevented due to the forces acting on the front of the towed vehicle by the translating components of the two legs of the tow bar.

Further, in all embodiments, a means for rotational mounting of the legs 12 to the hitch 18 of the towing vehicle is preferred. Such a means for rotational mounting, while not necessary in a more Spartan embodiment of the device 10, serves a number of purposes. First, it allows the device 10 to collapse for storage. Second, it allows the device 10 to adjust the angles of the legs 12 from the trailer hitch 18 to accommodate mounting to the front of different vehicles 20 since some are wider or narrower than others. Also, it allows the device 10 when engaged to a vehicle 20 and backing up to rotate in its engagement to the hitch 18 slightly if needed. Of course the device 10 can be made with a solid, non-rotatable mount to the trailer hitch 18 and still provide benefits and utility superior to conventional devices. Consequently, the employment of the means for rotational mounting to the trailer hitch, while preferred in the embodiments herein, can be optional.

As shown in the embodiments of the device 10, a locking means to prevent translation of the components forming the leg 12 from collapsing is provided and depicted as mechanical locking mechanism 22. As shown the locking mechanism employs a biased pin 27 which operatively engages with a slot 29 on the interior of the interior or rear leg 16 to maintain the components forming the leg 12 in an expanded position. As noted the biased pin 27 could also be an electronically activated solenoid or other remotely activatable locking device for a remotely activated model. As pictured, the handle 30 can be manually employed to disengage the biased pin 27 from the slot 29 to allow translation of the leg parts with each other.

While all of the fundamental characteristics and features of the invention have been shown and described herein, with reference to particular embodiments thereof a latitude of modification, various changes and substitutions are intended in the foregoing disclosure, and it will be apparent that in some instance, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A towing apparatus for engaging a towing vehicle to a towed vehicle, comprising:
a pair of legs, each leg having a front leg component translatably engaged to a rear leg component;
each front leg component adapted for engagement adapted at a at a hitch end for engagement with said towing vehicle;
each rear leg component adapted for engagement at an attachment mend, with said towed vehicle;
each of said pair of legs having an extended position wherein said rear leg component is translated a total distance of translation away from said front leg component;
each of said pair of legs having a collapsed position wherein said front leg component is translated said total distance of translation toward said rear leg component.

2. The towing apparatus of claim 1 additionally comprising:
means to resist translation of said of said front leg component toward said rear leg component for a resistance distance portion of said total distance of translation.

3. The towing apparatus of claim 2 wherein said means to resist translation is a means for biasing said front leg component away from said rear leg component.

4. The towing apparatus of claim 2 wherein said means to resist translation is a damper from a group of dampers consisting of hydraulic dampers and frictional dampers.

5. The towing apparatus of claim 4 wherein said damper has a first end engaged with said front leg component and a second end engaged with said rear leg component.

6. The towing apparatus of claim 2 wherein said means to resist translation includes a damper and means for biasing said front leg component away from said rear leg component.

7. The towing apparatus of claim 2 wherein said total distance of translation includes said resistance distance portion determined by said means to resist translation and a free travel portion of said total distance of translation wherein translation is unresisted.

8. The towing apparatus of claim 3 wherein said total distance of translation includes said resistance distance portion determined by said means for biasing, and a free travel portion of said total distance of translation wherein translation is unresisted.

9. The towing apparatus of claim 4 wherein hydraulic damper resists said translation toward both of said extended position and said collapsed position.

10. The towing apparatus of claim 6 wherein said hydraulic damper resists said translation toward both of said extended position and said collapsed position.

11. The towing apparatus of claim 1 additionally comprising:
means for locking each of said pair of legs in said extended position.

12. The towing apparatus of claim 2 additionally comprising:
means for locking each of said pair of legs in said extended position.

13. The towing apparatus of claim 3 additionally comprising:
means for locking each of said pair of legs in said extended position.

14. The towing apparatus of claim 4 additionally comprising:
means for locking each of said pair of legs in said extended position.

15. The towing apparatus of claim 6 additionally comprising:
means for locking each of said pair of legs in said extended position.

16. The towing apparatus of claim 7 additionally comprising:
means for locking each of said pair of legs in said extended position.

17. The towing apparatus of claim 9 additionally comprising:
means for locking each of said pair of legs in said extended position.

18. The towing apparatus of claim 10 additionally comprising:
means for locking each of said pair of legs in said extended position.

19. The towing apparatus of claim 1 additionally comprising:
means for rotational engagement of said hitch end of said front leg components to said vehicle.

20. The towing apparatus of claim 2 additionally comprising:
means for rotational engagement of said hitch end of said front leg components to said vehicle.

21. The towing apparatus of claim 3 additionally comprising:
means for rotational engagement of said hitch end of said front leg components to said vehicle.

22. The towing apparatus of claim 4 additionally comprising:
means for rotational engagement of said hitch end of said front leg components to said vehicle.
